(19) United States
(12) Patent Application Publication
(10) Pub. No.: US 2018/0265085 A1
(43) Pub. Date: Sep. 20, 2018

(54) DYNAMICALLY AFTER VEHICLE FOLLOWING DISTANCE USING PROBE DATA

(71) Applicant: Philip Mallinger, Shelby Township, MI (US)

(72) Inventor: Philip Mallinger, Shelby Township, MI (US)

(21) Appl. No.: 15/459,659

(22) Filed: Mar. 15, 2017

(51) Int. Cl. B60W 30/16; B60W 30/14; B60W 30/02

(52) U.S. Cl. CPC B60W 30/16; B60W 30/143; B60W 30/02; B60W 2550/308; B60W 2750/308; B60W 2520/18; B60W 2420/52; B60W 2520/28; B60W 2520/14; B60W 2520/16; B60W 2720/10

(57) ABSTRACT

A system is disclosed for use with a motor vehicle for analyzing a user set vehicle following distance (VFD) in view of at least one type of information provided to an adaptive cruise control system (ACCS) of the vehicle, and determining a new VFD. The ACCS enables a user to set a user desired speed and a user desired VFD. The ACCS may have a processor that receives data obtained from a data source remote from the vehicle, with the data relating to at least one of a changing traffic condition, a changing road condition or a changing weather condition. The processor may analyze the data to determine if the user set VFD should be modified, and if so, may determine a new VFD.

### FIELD

The present disclosure relates to systems and method for automatically controlling the speed of a vehicle, and more particularly to an adaptive cruise control system for a motor vehicle that automatically monitors road conditions and adjusts a following distance in accordance with changing road conditions.

### BACKGROUND

The statements in this section merely provide background information related to the present disclosure and may not constitute prior art.

Adaptive cruise control systems are employed on motor vehicles such as cars, trucks, SUVs, minivans and full size vans for the purpose of enhancing the driving experience of the user. More particularly, present day adaptive cruise control systems operate to maintain a user set vehicle speed, and in some instances a user set vehicle following distance. The vehicle following distance will be understood to be the distance between the user's vehicle and another vehicle in front of the user's vehicle. Present day adaptive cruise control systems with this feature enable the system to modify the vehicle's speed, in real time, to maintain the user set vehicle following distance as the distance between the user's vehicle and the vehicle ahead of the user's vehicle changes.

In spite of the wide spread use and popularity of cruise control systems, there remains a need for an adaptive cruise control system with even more intelligence to determine when an existing following distance is not suitable for traffic or environmental conditions, and which is able to automatically modify the following distance to optimally suit traffic and/or environmental conditions. With the real time availability of cloud-based real time probe data, such as weather data, traffic data, road construction data, etc., the opportunity exists to significantly broaden the intelligence of an adaptive cruise control system to leverage this real time data in a manner to even further improve the utility of present day adaptive cruise control systems.

### SUMMARY

In one aspect the present disclosure relates to a system for use with a motor vehicle. The system may comprise an adaptive cruise control system (ACCS) for enabling a user to set a user desired speed and a user desired vehicle following distance. The ACCS may include a processor. The processor may be configured to receive data, obtained from a data source remote from the vehicle, which is indicative of at least one of a changing traffic condition, a changing road condition or a changing weather condition. The processor may also be configured to analyze the data to determine whether a user set vehicle following distance should be modified. Still further, the processor may also be configured to determine that the user set vehicle following distance should be modified, and then to determine a new vehicle following distance.

In another aspect the present disclosure relates to a system for use with a motor vehicle. The system may comprise an adaptive cruise control system (ACCS) for enabling a user to set a user desired speed and a user desired vehicle following distance. The ACCS may include a processor configured to receive data, obtained from a data source remote from the vehicle, which is indicative of at least one of a changing traffic condition, a changing road condition or a changing weather condition. The processor may also be configured to receive data, obtained from at least an on-board sensor or on-board system of the vehicle, and to analyze the data obtained from both the remote data source and the at least one on-board sensor or on-board system of the vehicle. The processor may further be configured to determine whether a user set vehicle following distance should be modified, and if so, to determine a new vehicle following distance. The ACCS may also be configured to implement the new vehicle following distance without action by the user.

In still another aspect the present disclosure relates to a method for system for use with a motor vehicle. The method may comprise using an adaptive cruise control system (ACCS) to enable a user to set a user desired speed and a user desired vehicle following distance. The method may further comprise using a processor operably associated with the ACCS to receive data, obtained from a data source remote from the vehicle, which is indicative of at least one of a changing traffic condition, a changing road condition or a changing weather condition. The method may further comprise analyzing the data to determine whether a user set vehicle following distance should be modified. The method may further comprise determining a new vehicle following distance when the determination has been made that the user set vehicle following distance needs to be modified.

### BRIEF DESCRIPTION OF THE DRAWINGS

The drawings described herein are for illustration purposes only and are not intended to limit the scope of the present disclosure in any way.

FIG. 1 is a high level block diagram of one example of a system in accordance with the present disclosure;

FIG. 2, is a flowchart illustrating various operations that the system of FIG. 1 may perform in monitoring a vehicle following distance, determining a new following distance and setting the vehicle's adaptive cruise control system to the newly determined following distance.

### DETAILED DESCRIPTION

The following description is merely exemplary in nature and is not intended to limit the present disclosure, application, or uses. It should be understood that throughout the drawings, corresponding reference numerals indicate like or corresponding parts and features.

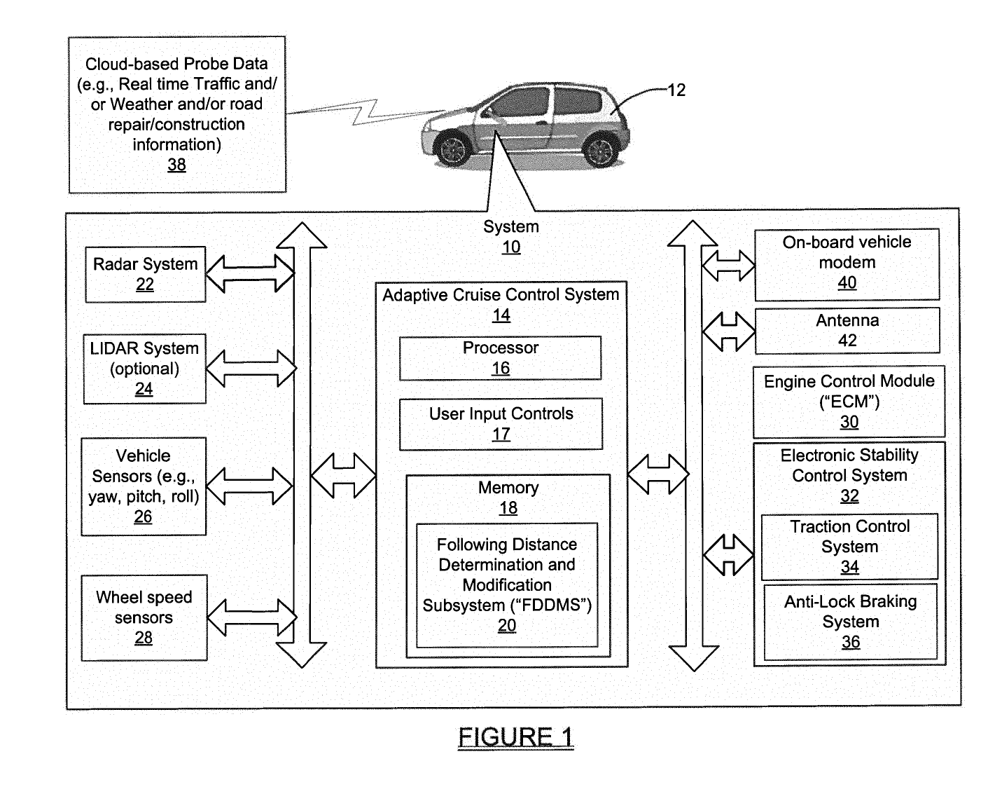

Referring to FIG. 1 there is shown a system 10 for monitoring and adjusting a vehicle following distance of a vehicle 12. The system 10 may include an adaptive cruise control system 14 (“ACCS 14”) having a processor 16, user input controls 17 for enabling the user to set a vehicle speed and vehicle following distance, a memory 18 and a following distance determination and control subsystem 20 (hereinafter “FDCS 20”). Optionally, the FDCS 20 may be stored in a separate memory remote from the processor 16 but accessible by the processor over a communications bus of the system 10.

The ACCS 14 may be in communication with a plurality of other vehicle subsystems such as a radar system 22, an optional LIDAR (Light Detection and Ranging) system 24, optionally one or more vehicle sensors such as one or more of roll, pitch and/or yaw sensors 26, and vehicle wheel speeds sensors 28. The ACCS 14 may also be in communication with other major subsystems of the vehicle 12, optionally an engine control module (“ECM”) 30 and optionally an electronic stability control (“ESC”) system 32. The ESC system 32 may include a traction control system 34 and an anti-lock braking (“ABS”) system 36. The ESC system 32 may report real time traction and braking information to the ACCS 14 that aids the ACCS 14 in making adjustments to the user set vehicle following distance. Optionally, the system 10 may be configured to receive cloud-based probe data from a probe data source 38. Probe data may include any data that provides an indication of road conditions in the vehicle's 12 path of travel, for example road or traffic conditions some distance ahead (e.g., 0.25-1.0 mile ahead) of the vehicle. More specifically, probe data may include real time road construction/repair information that is causing a traffic slow down, real time weather information that is affecting traffic movement, real time traffic congestion that is causing a traffic slowdown, or any other condition having a bearing on driving conditions ahead of the vehicle 12. The system 10 may optionally include an on-board modem 40 (e.g., 3G or 4G) and a suitable antenna 42 for communicating wirelessly with the cloud-based probe data source 38 and supplying received information to the ACCS 14. The on-board model 40 and antenna 42 may also be used to report the vehicle's 12 real time position to the cloud-based probe data source 38 and to upload pertinent probe data produced by the system 10 to the cloud-based probe data source. The system 10 may provide information from one or more of the above-described information sources, for example from remote cloud-based probe data source 38 together with one or more of the systems 22, 24, 26, 28 and 30 to the ACCS 14, which enables the ACCS 14 to monitor the vehicle following distance and to determine if the vehicle following distance needs to be modified from a user set following distance, and if so what a new vehicle following distance should be set to.

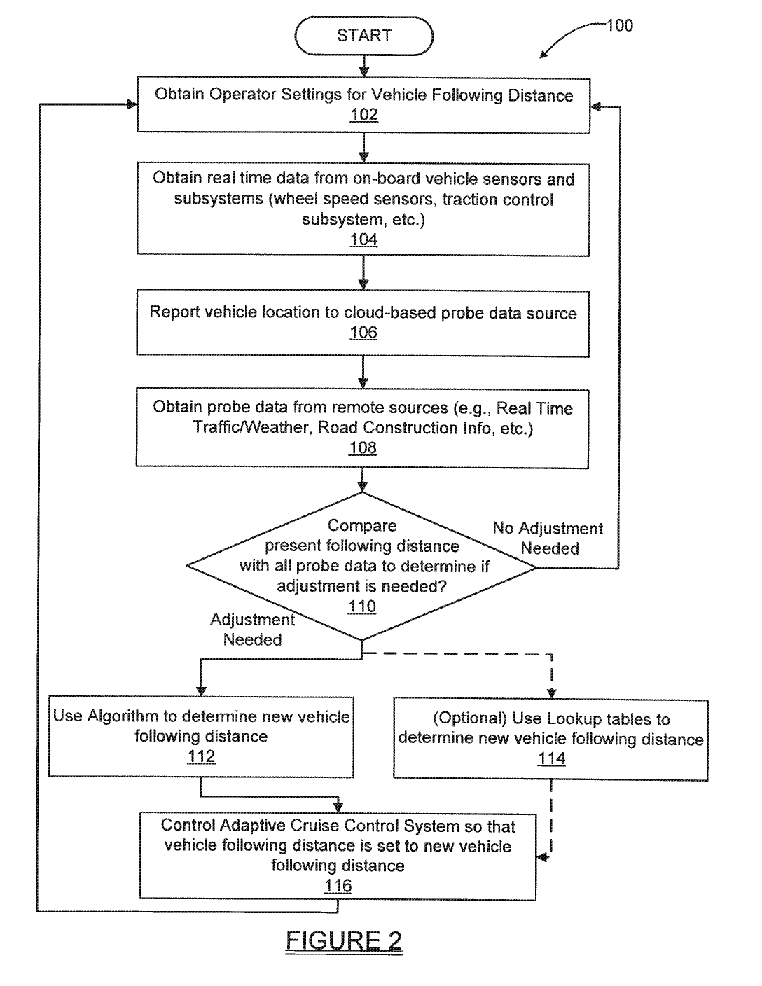

Referring to FIG. 2, a flowchart 100 is shown of various operations that may be performed by the system 10 in monitoring the vehicle following distance, determining if a change in the vehicle following distance is needed, and if so what the new vehicle following distance is to be set at.

At operation 102 the system 10 may obtain operator settings that are input by the vehicle operator to the ACCS 14 through the user input controls 17. At operation 104 the system 10 may obtain real time information and data from on-board vehicle sensors and subsystems, for example from one or more of systems 22, 24, 26, 28 and 30, which may have a bearing on what a suitable real time vehicle following distance should be set at. At operation 106 the system 10 may report the GPS coordinates of the vehicle 12 to the cloud-based probe data system 38. At operation 108, the system 10 may receive probe data from the cloud-based probe data source 108. At this point, then, it will be understood that the ACCS 14 may have information and data obtained from both on-board vehicle systems as well as at least one remote information/data source, that all relates to at least one of road conditions, traffic conditions, weather conditions, etc.

At operation 110, the ACCS 14 uses some or all of the above information made available to it to determine if adjustment is needed to the user set vehicle following distance. This determination may involve determining, based on the probe data and data and information from on-board systems 22, 24 and 30, as well as sensors 26 and 28, if the vehicle following distance needs to be increased or may even be decreased. At this operation the system 10 is determining whether probe data associated with traffic conditions, road conditions or weather conditions, and particularly those conditions at some distance (e.g., ¼ mile to 1 mile or more) ahead of the vehicle in front of the operator's vehicle, warrant modifying the user's presently set vehicle following distance. Operation 110 may involve a suitable algorithm that uses the probe data to determine if various factors, for example the speed of vehicles ¼ mile to 3 miles ahead of the user's vehicle, warrants a modification to the user set vehicle following speed. If the answer at operation 110 is “No”, then operations 102-108 may be repeated.

If the check at operation 110 produces a “Yes” answer, then a suitable algorithm may be used, as indicated at operation 112, to determine a new vehicle following speed. The algorithm implemented at operation 112 may involve looking at various types of probe data, such as how traffic is flowing at various locations (e.g., ½ mile, 1 mile, 3, mile, etc.) ahead of the user's vehicle, what the average vehicle speed is for vehicle's at different distances ahead of the user's vehicle, whether the user's vehicle is approaching a traffic shift or detour, whether weather conditions are changing in the direction that the user's vehicle is heading, whether a lane closure exists at some distance ahead of the user's vehicle, weather an accident has been reported at some distance ahead of the user's vehicle, etc. The algorithm may apply weights to one or more of the foregoing types of information. The algorithm may also factor in data generated by on-board vehicle systems such as the vehicle's traction control system (TCS) 34, the vehicle's yaw, pitch and roll sensors 26 and/or its wheel speed sensors 28, in making a determination of what a new vehicle following speed should be. The ACCS 14, and particularly its processor 16, may use the FDDMS 20 to perform the comparison operation (operation 110) and the determination operation (operation 112). These operations are performed in real time, and the determination and application of a new vehicle following speed may appear seamless to the vehicle operator.

Optionally, as indicated at operation 114, the determination of a new vehicle following distance may be made using one or more look-up tables that involve one or more, or all, of the above types of probe data and information from on-board vehicle systems and sensors. The look-up table may be constructed with a plurality of vehicle following distances that have been predetermined to be suitable for varying vehicle speeds, traffic conditions and weather conditions. Optionally, a combination of the algorithm described in connection with operation 112 and the look-up table of operation 114 may be used by the FDDMS 20 of the ACCS 14 to determine the new vehicle following speed. At operation 116 the ACCS 14 applies the new vehicle following distance. Operations 102-110 may then be repeated.

The system 10 thus makes use of a wide variety of probe data and information from on-board vehicle sensors and subsystems to anticipate when a user set vehicle following distance needs to be changed. The system 10 is not just monitoring the existing vehicle following distance and making changes based solely on the vehicle ahead of the user's vehicle, but rather intelligently determining if road conditions and/or traffic conditions and/or weather conditions, at some distance well ahead of the user's vehicle, warrant modifying the user's currently set vehicle following distance. The system 10 can therefore provide an added degree of safety to the user by intelligently anticipating when the user set vehicle following distance should be modified, before a road condition, traffic or weather condition presents itself, which makes the adjustment advisable.

1. A system for use with a motor vehicle, the system comprising:
an adaptive cruise control system (ACCS) for enabling a user to set a user desired speed and a user desired vehicle following distance, the ACCS including a processor;
the processor configured to:
receive data, obtained from a data source remote from the vehicle, wherein the remote data source is a cloud-based data source that provides information pertaining to at least one of a changing traffic condition, a changing road condition, or a changing weather condition;
to analyze the data to determine whether a user set vehicle following distance should be modified; and
when a determination is made that the user set vehicle following distance should be modified, to determine a new vehicle following distance;

2. The system of claim 1, wherein the ACCS is configured to implement the new vehicle following distance without action by the user.

3. (canceled)

4. The system of claim 1, wherein the ACCS is further configured to receive information from an electronic stability control (ESC) system of the vehicle and to use the information from the ESC in analyzing the data to determine whether the user set vehicle following distance should be modified.

5. The system of claim 1, wherein the ACCS is further configured to receive and use information from a radar system on-board the vehicle when analyzing whether the user set vehicle following distance should be modified.

6. The system of claim 1, wherein the ACCS is further configured to receive and use information from a light detection and ranging (LIDAR) system on-board the vehicle when analyzing whether the user set following distance should be modified.

7. The system of claim 1, wherein the ACCS is configured to receive and use information from at least one of a yaw, pitch or roll sensor on-board the vehicle when analyzing whether the user set following distance should be modified.

8. The system of claim 1, wherein the ACCS is configured to receive and use information from a plurality of wheel speeds sensors carried on-board the vehicle.

9. The system of claim 1, wherein the system includes a modem for communicating wirelessly with the remote data source.

10. The system of claim 1, wherein:
the remote data source is a cloud-based data source that provides at least one of data and information pertaining to at least one of the changing traffic condition, the changing road condition or the changing weather condition;
wherein the ACCS is further configured to receive information from an electronic stability control (ESC) system of the vehicle and to use the information from the ESC in analyzing the data to determine whether the user set vehicle following distance should be modified; and
wherein the ACCS is configured to implement the new vehicle following distance without action by the user.

11. A system for use with a motor vehicle, the system comprising:
an adaptive cruise control system (ACCS) for enabling a user to set a user desired speed and a user desired vehicle following distance, the ACCS including a processor;
the processor configured to:
receive data, obtained from a data source remote from the vehicle, wherein the remote data source is a cloud-based data source that provides information pertaining to at least one of a changing traffic condition, a changing road condition, or a changing weather condition;
receive data, obtained from at least an on-board sensor or on-board system of the vehicle;
to analyze the data obtained from both the remote data source and the at least one on-board sensor or on-board system of the vehicle, to determine whether a user set vehicle following distance should be modified;
when a determination is made that the user set vehicle following distance should be modified, to determine a new vehicle following distance; and
wherein the ACCS is configured to implement the new vehicle following distance without action by the user.

12. (canceled)

13. The system of claim 11, wherein the at least one on-board sensor or on-board system comprises at least one of:
an electronic stability control (ESC) system of the vehicle;
a radar system of the vehicle;
a light detection and ranging (LIDAR) system of the vehicle;
a plurality of wheel sensors of the vehicle; and
a yaw, pitch or roll sensor of the vehicle.

14. The system of claim 11, wherein the ACCS uses an algorithm to obtain the new vehicle following distance.

15. The system of claim 11, wherein the ACCS uses at least one look-up table to obtain the new vehicle following distance.

16. A method for system for use with a motor vehicle, the method comprising:
using an adaptive cruise control system (ACCS) to enable a user to set a user desired speed and a user desired vehicle following distance;
using a processor operably associated with the ACCS to:
receive data, obtained from a data source remote from the vehicle, wherein the remote data source is a cloud-based data source that provides information pertaining to at least one of a changing traffic condition, a changing road condition, or a changing weather condition;
analyze the data to determine whether a user set vehicle following distance should be modified; and
when a determination is made that the user set vehicle following distance should be modified, to determine a new vehicle following distance.

17. The method of claim 16, further comprising using the ACCS to implement the new vehicle following distance without user intervention.

18. The method of claim 16, further comprising using information obtained from at least one sensor or at least one system on-board the vehicle in determining if the user set vehicle following distance should be modified.

19. The method of claim 18, wherein using information obtained from at least one sensor or at least one system on-board the vehicle comprises using information or data provided by at least one of:
a plurality of wheel speed sensors of the vehicle;
at least one of a yaw, pitch or roll sensor of the vehicle;
a traction control system of the vehicle; and
an electronic stability control system of the vehicle.

20. The method of claim 17, wherein using the ACCS to implement the new vehicle following distance comprises using at least one of:
an algorithm processed by the processor; and
a look-up table accessed by the processor.
